(19) United States
(12) Patent Application Publication
(10) Pub. No.: US 2009/0286941 A1
(43) Pub. Date: Nov. 19, 2009

(54) Process For Preparing Organopolysiloxanes Having Quaternary Ammonium Groups

(75) Inventor: Christian Herzig, Waging (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/436,283

(22) Filed: May 6, 2009

(30) Foreign Application Priority Data
May 19, 2008 (DE) 10 2008 001 867.8

(51) Int. Cl. C08G 77/388

(52) U.S. Cl. 525/478

(57) ABSTRACT

Organopolysiloxanes having quaternary ammonium groups are prepared by first,

condensing organopolysiloxanes having a terminal unit

HO—SiR²₂O_{1/2} (I)

with aminosilanes

AₐR_{b}Si(OR¹)_{4-(a+b)} (II),

where
A is a monovalent SiC-bonded organic radical containing at least one tertiary amino group and free of primary or secondary amino groups,
R a monovalent C₁₋₁₈ hydrocarbon radical,
R¹ is a C₁₋₈ alkyl radical,
a is 1 or 2,
b is 0 or 1, and
a+b is 1 or 2,
   optionally with catalysts, to obtain organopolysiloxanes having tertiary amino groups,
   and,
   second,
   partly or fully quaternizing the organopolysiloxanes obtained in the first step with alkylating agents,
   no bases being added in the second step, and
   water is substantially absent.

### CROSS-REFERENCE TO RELATED APPLICATIONS

This application claims priority to German application DE 10 2008 001 867.8 filed May 19, 2008, which is herein incorporated by reference.

### BACKGROUND OF THE INVENTION

1. Field of the Invention

The invention relates to a process for preparing organopolysiloxanes having quaternary ammonium groups.

2. Background Art

Compounds with quaternary nitrogen atoms, often referred to as quats for short, are known.

DE 32 36 466 A1 (corresponding to U.S. Pat. No. 4,417,066) describes a process for preparing siloxanes which contain quaternary ammonium halide groups by reaction of siloxanols with silanes which contain quaternary ammonium halide groups and at least two condensable alkoxy groups. The quaternary ammonium groups of the silanes are bonded to the silicon atom via divalent hydrocarbon bridges which may also contain oxygen atoms in the form of ether or hydroxyl groups. The quat-functional silanes in salt form prepared separately beforehand have a poor solubility in siloxanes; comparatively severe reaction conditions of approx. 150° C. over several hours are needed, and, moreover, volatile by-products of the preparation process have to be removed at the end.

A similar process is known from U.S. Pat. No. 5,602,224, in which a siloxanol is reacted with a quat-functional trialkoxysilane with the aid of an amine. The quaternary nitrogen may contain polyether substituents.

A method for condensing siloxanols with (m)ethoxy-containing organosilanes is described in U.S. Pat. No. 6,525,130. The method includes the use of a basic catalyst, an emulsifier package, and organosilanes functionalized virtually as desired, which have 2 or 3 (m)ethoxy groups. Tertiary or quaternary aminosilanes are not disclosed.

EP 1 063 344 A2 (corresponding to U.S. Pat. No. 6,515,095) describes formulations for fiber and textile treatment which comprise silicones containing at least one structural element which consists of a nitrogen-containing silane unit which is also substituted by 2 diorganosiloxane substituents and one alkoxy group. The formulation contains at least one type of emulsifier. The nitrogen-containing silane unit is not described as a quaternary amine. This amine unit cannot form a chain terminal group. In order to obtain terminal amino groups, a further reaction step with a nitrogen-containing dialkoxysilane is required. A process for preparing terminal quat siloxanes is not described.

DE 196 52 524 A1 and WO 2004/044306 A1 each describe methods for preparing quat-functional siloxanes. DE 196 52 524 A1 describes the preparation of emulsions of quat-functional siloxanes. The quaternization is achieved by repeated alkylation of customary aminosiloxanes having prim./sec. amino groups by means of methyl tosylate. For the polyalkylation, large amounts of alkylating agent are needed, and the sulfonic acid released has to be neutralized with large amounts of sodium hydrogencarbonate and in the presence of water (in amounts of 20-95.99% by weight of water, preferably 60-90% by weight of water, based in each case on the total weight of the emulsion) to obtain emulsions with a high salt burden. As a result of performing the process in water, it is necessary to work at room temperature in order not to destroy the emulsions, which leads to long reaction times and hence to long plant occupation and uneconomic space-time yields.

According to WO 2004/044306 A1, terminally quat-functional siloxanes are obtained in a 2-stage synthesis sequence from epoxy precursors: first they are reacted with a sec./tert. diamine and then alkylated with methyl tosylate. Neither is a condensation process.

### SUMMARY OF THE INVENTION

It was an object of the invention to provide a process for preparing organopolysiloxanes having quaternary ammonium groups, in which the above-described disadvantages are avoided, which is rapid and economically viable, in which organopolysiloxanes having quaternary ammonium groups are obtained with a lower salt burden and neat or substantially neat, and in which the active ingredient is thus obtained in a higher concentration. It was a further object of the invention to provide organopolysiloxanes which have quaternary ammonium groups and have siloxane units which contain both quaternary ammonium groups and reactive groups, such as alkoxy or hydroxyl groups. These and other objects are achieved by the invention, wherein silanol-terminal organopolysiloxanes are reacted with tertiaryamine-functional alkoxysilanes followed by quaternization, wherein no basic catalysts are added during quaternization, and the reaction is conducted in the presence of at most 10% of water, preferably water-free.

### DETAILED DESCRIPTION OF THE PREFERRED EMBODIMENT(S)

The invention thus provides a process for preparing organopolysiloxanes having quaternary ammonium groups by:

in a first step,
condensing organopolysiloxanes (1) which have at least one terminal unit of the general formula

HO—SiR²₂O_{1/2} (I)

with aminosilanes (2) of the general formula

AₐR_{b}Si(OR¹)_{4-(a+b)} (II),

where
A is a monovalent SiC-bonded organic radical which contains at least one tertiary amino group, with the proviso that the A radical contains no primary or secondary amino groups,
R may be the same or different and is a monovalent hydrocarbon radical having 1 to 18 carbon atoms,
R¹ is an alkyl radical having 1 to 8 carbon atoms,
a is 1 or 2 and
b is 0 or 1,
   with the proviso that the sum of a+b is 1 or 2,
   optionally in the presence of catalysts (3), to obtain organopolysiloxanes (4) having tertiary amino groups, and,
   in a second step,
   partly or fully quaternizing the nitrogen atoms from the organopolysiloxanes (4) obtained in the first step with alkylating agents (5),
   with the proviso that no bases are added in the second step and
   that, in the process, water is used in amounts of less than 10% by weight, preferably less than 4% by weight, more preferably less than 1% by weight based in each case on the total weight of the components (1), (2), if appropriate (3) and (5). Particular preference is given to performing the process according to the invention in the absence of water.

Quaternary ammonium groups are derivatives of the ammonium group in which all four hydrogen atoms are replaced by four N—C-bonded (optionally substituted) hydrocarbon groups such as alkyl groups.

The organopolysiloxanes (1) used, in addition to the siloxane units of the formula (I), preferably contain siloxane units of the formula

R_{d}SiO (III)

where R is as defined above and
d is 0, 1, 2 or 3, preferably 2.

The organopolysiloxanes (1) used are preferably linear and may thus contain one or two end groups of the formula (I). However, the organopolysiloxanes (1) may also be branched and then contain more than two of the end groups of the formula (I). The organopolysiloxanes (1) may, however, also be copolymers with structural units other than siloxane units.

The organopolysiloxanes (1) used are preferably those of the general formula

HOR₂SiO(SiR₂O)ₙSiR₂OH (IV),

where R is as defined above and
n is 0 or an integer from 1 to 1000.

The A radical is preferably a monovalent hydrocarbon radical which has 3 to 50 carbon atoms and contains at least one tertiary amino group.

The A radical is preferably a radical of the general formula

—R³(—NR⁴—R³)ₙ—NR²₂ (V),

where
R² may be the same or different and is a monovalent hydrocarbon radical which has 1 to 18 carbon atoms and may contain one or more tertiary amino groups,
R³ is a divalent SiC-bonded organic radical having 1 to 18 carbon atoms, preferably a divalent hydrocarbon radical having 1 to 18 carbon atoms,
R⁴ is a monovalent hydrocarbon radical having 1 to 18 carbon atoms and
z is 0 or an integer from 1 to 10, preferably 0, 1 or 2.

The organopolysiloxanes (1) used preferably have a viscosity of 2 to 100,000 mPa·s at 25° C., preferably 10 to 20,000 mPa·s at 25° C.

Examples of hydrocarbon radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as cyclopentyl, cyclohexyl, cycloheptyl and methylcyclohexyl radicals; aryl radicals such as the phenyl, naphthyl, anthryl and phenanthryl radicals; alkaryl radicals such as o-, m-, p-tolyl radicals, xylyl radicals and ethylphenyl radicals; and aralkyl radicals such as the benzyl radical and the α- and β-phenylethyl radicals.

Examples of alkyl radicals R¹ are the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, and octyl radicals such as the n-octyl radical and isooctyl radicals such as the 2,2,4-trimethylpentyl radical. R¹ is preferably a methyl or ethyl radical.

Examples of hydrocarbon radicals R apply completely to hydrocarbon radicals R². R² is preferably a methyl or ethyl radical.

Examples of hydrocarbon radicals R³ are alkylene radicals, such as radicals of the formula

—CH₂—, —CH₂CH₂—, —CH₂CH₂CH₂—, —CH₂CH₂CH₂CH₂—, —CH(CH₃)—, —C(CH₃)₂, —CH₂CH₂CH(CH₃)—, and —CH₂CH₂C(CH₃)₂CH₂—.

Examples of hydrocarbon radicals R also apply completely to hydrocarbon radicals R⁴. R⁴ is preferably a methyl radical.

Examples of A radicals are those of the formula

—CH₂CH₂CH₂—N(CH₃)₂, —CH₂CH₂CH₂—N(CH₂CH₃)₂, —CH₂CH₂CH₂—N(CH₂CH₃)CH₃, —CH₂CH₂CH₂—N(CH₃)—CH₂CH₂—N(CH₃)₂, —CH₂CH₂CH₂—N(CH₃)—CH₂CH₂CH₂—N(CH₃)₂, —CH₂CH₂CH₂—N[CH₂CH₂—N(CH₃)₂]₂, and —CH₂CH₂CH₂—N[CH₂CH₂CH₂—N(CH₃)₂]₂.

Preference is given to using aminosilanes (2) of the formula ARSi(OR¹)₂ and ASi(OR¹)₃, particular preference being given to ASi(OR¹)₃, where A, R and R¹ are each as defined above.

In the first stage of the process according to the invention, aminosilanes (2) are preferably used in amounts of 0.2 to 3 mol, preferably 1 to 3 mol, of alkoxy group —OR¹ in (2) per mole of hydroxyl group —OH in the organopolysiloxane (1).

In the first step of the process, it is possible to use catalysts (3) which accelerate the condensation. Preference is given to using basic compounds. In the case of use of organic amines, those having a pKₐ of at least 9 are preferred, but even then, compared to condensation without addition of catalyst, only a small increase in the reaction rate is achieved. Preference is given to using, as catalysts (3), alkali metal or alkaline earth metal bases, among which the hydroxides, alkoxides and siloxanolates are preferred. Particular preference is given to lithium and sodium bases. Preferred examples of catalysts (3) are lithium hydroxide, lithium oxide, lithium siloxanolate, and the alkoxides of lithium, such as lithium methoxide, lithium ethoxide, lithium propoxide and lithium butoxide. These may be used diluted in organic solvents or in undiluted form.

In the first step of the process according to the invention, the catalyst (3) is preferably used in amounts of 10 to 10,000 ppm by weight, preferably 20 to 2000 ppm by weight, based on the total weight of the organopolysiloxanes (1) and aminosilanes (2).

The catalysis of the condensation step should be understood such that this reaction is accelerated under otherwise constant physical boundary conditions. Temperature increase is a further accelerating factor. Particularly at high temperatures, with a long duration and using strongly basic catalysts, considerable rearrangement of the siloxane skeleton (equilibration) is typically obtained, with the side-effect that cyclic siloxanes are formed. Since the lower homologs of the cyclic siloxanes are volatile compounds and therefore have to be removed from the product, such a reaction regime is undesired. Preference is therefore given to adjusting catalyst strength and amount, and reaction temperature and reaction duration, such that condensation proceeds to completion, but only minor formation of cyclic siloxanes occurs.

In principle, metal compounds known as condensation catalysts, such as organotitanates, organozirconates, and tin salts, bismuth salts or lead salts, are also capable of functioning in the inventive system. However, their use is not preferred for ecological reasons.

At the end of the condensation step, the catalysts (3) can be neutralized, thus stopping the rearrangement of the organopolysiloxane.

The first stage of the process according to the invention, the condensation, is preferably performed at a temperature of 20 to 150° C., particular preference being given to the range of 50 to 100° C. depending on the catalyst type and amount, and the reaction time. The condensation is preferably performed at the pressure of the surrounding atmosphere, i.e. at about 1020 hPa, but it can also be performed at higher or lower pressures.

If desired, the alkoxy functions —OR¹ of the aminosilanes (2), whose alkoxy functions have not been depleted in the condensation owing to a stoichiometry of Si—OR¹/SiOH>1, can be exchanged for larger and hence less reactive radicals by transesterification. During or after the condensation, the alkoxy groups —OR¹ can be exchanged partly or fully by addition of suitable alcohols (6), and the (volatile) alcohols R¹OH released can be removed by distillation. This process can serve to stabilize the resulting organopolysiloxanes having quaternary ammonium groups.

The alcohols (6) used are preferably those of the formula

R¹OH (VI)

where
R⁵ is an SiC-bonded hydrocarbon radical which has 4 to 30 carbon atoms and may contain one or more ether oxygen atoms. Examples of R⁵ radicals are radicals of the formula C₄H₉—, C₆H₁₃—, C₈H₁₇—, C₁₀H₂₁—, C₁₂H₂₅—, C₄H₉(OCH₂CH₂)₂—, CH₃(OC₃H₆)₂—, C₆H₁₃OC₂H₄— and C₆H₁₃(OC₂H₄)₂—. Examples of alcohols (6) are butanol, hexanol, octanol, decanol, dodecanol, diethylene glycol monobutyl ether, dipropylene glycol monomethyl ether, hexylglycol, hexyldiglycol and Guerbet alcohols.

Alcohols (6) are preferably used in amounts of 1 to 5 mol, preferably 1.5 to 3 mol, per mole of alkoxy groups —OR¹ in the aminosilane (2).

After the first step, by virtue of the aminosilanes (2) incorporated by condensation, organopolysiloxanes (4) with tertiary amino groups are obtained.

The nitrogen atoms in the organopolysiloxanes (4) are quaternized by means of alkylating agents (5) known to those skilled in the art. The quaternizing agents used may be all known compounds which contain sufficiently electrophilic structural regions to react with the tertiary amino groups in the organopolysiloxanes (4).

The alkylating agents (5) used are preferably those of the formula

R⁶—X (VII)

where
R⁶ is a monovalent hydrocarbon radical which has 1 to 12 carbon atoms and may contain one or more ether oxygen atoms,
X is a radical which, in the alkylation of the nitrogen atoms in the organopolysiloxanes (4), constitutes a counterion X⁻ to the positive charge on the quaternary nitrogen atom, with the proviso that X is not a halogen atom and hence the counterion X⁻ is not a halide.

R⁶ is preferably a linear, branched or cyclic alkyl radical having 1 to 6 carbon atoms. Examples of R⁶ radicals are the methyl, ethyl, propyl, isopropyl, butyl, isobutyl and cyclohexyl radicals.

Examples of alkylating agents (5) are dialkyl sulfates and sulfonic esters, such as dimethyl sulfate, diethyl sulfate, methyl p-toluenesulfonate, ethyl p-toluenesulfonate, propyl p-toluenesulfonate and sec-butyl p-toluenesulfonate.

In the second step of the process according to the invention, alkylating agent (5) is preferably used in amounts of 0.3 to 1.2 mol, more preferably 0.6 to 1.1 mol, per mole of alkylatable nitrogen atom in the organopolysiloxane (4).

The quaternization in the second step of the process according to the invention is effected preferably at 50 to 150° C., preferably at 60 to 110° C., and is preferably performed at the pressure of the surrounding atmosphere, i.e. at about 1020 hPa, but can also be performed at higher or lower pressures.

In the second step of the process, neutralization of the acids formed in the alkylation, such as sulfonic acid, is not necessary. The quaternization is effected preferably without addition of bases, such as sodium hydrogencarbonate, and without addition of water. This has the advantage that organopolysiloxanes having quaternary ammonium groups are obtained only with a low salt burden, and the organopolysiloxanes having quaternary ammonium groups may be obtained neat and not diluted in water, which leads to a higher active ingredient concentration of the quaternary ammonium groups. Organic solvents may be present if desired.

The invention further provides organopolysiloxanes having quaternary ammonium groups, selected from the group of

(i) organopolysiloxanes containing units of the formula

Q(R^{1′}O)₂SiO_{1/2} (VIII), and

R₂SiO (IX),

(ii) organopolysiloxanes containing units of the formula

R₂SiO (IX),

Q(R^{1′}O)SiO (X), and

(R^{1′}O)R₂SiO_{1/2} (XI),

(iii) organopolysiloxanes containing units of the formula

R₂SiO (IX),

(R^{1′}O)R₂SiO_{1/2} (XI), and

QSiO_{3/2} (XII),

and mixtures thereof, where
Q is a monovalent SiC-bonded organic radical which contains at least one quaternary ammonium group, and where a counterion X⁻ to the positive charge on the quaternary nitrogen atom is present in each case, with the proviso that the counterion is not a halide,
R^{1′} is R¹, R⁵ or a hydrogen atom, where
R, R¹ and R⁵ are each as defined above.

Q is preferably a monovalent hydrocarbon radical which has 3 to 50 carbon atoms and contains at least one quaternary ammonium group.

Q is preferably a radical of the formula

$$- {{{R}^{3}}^{{X}^{-}} ( - {NR}^{4} - {R}^{3} )}_{z \text{-} {z}^{′}} {( - {N}^{+} {R}^{4} {R}^{6} - {R}^{3} )}_{{z}^{′}} {- {N}^{+}}^{{X}^{-}} {R}_{2}^{2} {R}^{6} \qquad ( IX )$$

where R², R³, R⁴, R⁶ and z are each as defined above,
z′ is 0 or an integer from 1 to 10, preferably 0, 1 or 2, with the proviso that 0≦z−z′≦10,
   where a counterion X⁻ to the positive charge on the quaternary nitrogen atom is present in each case, with the proviso that the counterion is not a halide.

Examples of SiC-bonded organic radicals which have at least one quaternary ammonium group in the Q radical are

—CH₂CH₂CH₂—N⁺(CH₃)₃, —CH₂CH₂CH₂—N⁺(CH₃)₂CH₂CH₃, —CH₂CH₂CH₂—N⁺(CH₂CH₃)₃, —CH₂CH₂CH₂—N⁺(CH₂CH₃)₂CH₃, —CH₂CH₂CH₂—N⁺(CH₃)₂CH₂CH₂CH₂CH₃, —CH₂CH₂CH₂CH₂—N⁺(CH₃)₃, —CH₂CH₂CH₂CH₂—N⁺(CH₂CH₃)₂CH₃, —CH₂CH₂CH₂—N⁺(CH₃)₂—CH₂CH₂—N⁺(CH₃)₃, —CH₂CH₂CH₂—N⁺(CH₃)₂—CH₂CH₂CH₂—N⁺(CH₃)₃, —CH₂CH₂CH₂—N(CH₃)—CH₂CH₂CH₂—N⁺(CH₃)₃, —CH₂CH₂CH₂—N⁺(CH₃)₂—CH₂CH₂CH₂—N(CH₃)₂, —CH₂CH₂CH₂—N⁺(CH₃)[CH₂CH₂—N(CH₃)₂]₂, —CH₂CH₂CH₂—N⁺(CH₃)[CH₂CH₂—N(CH₃)₂] [CH₂CH₂—N⁺(CH₃)₃], —CH₂CH₂CH₂—N⁺(CH₃)[CH₂CH₂—N⁺(CH₃)₃]₂, and —CH₂CH₂CH₂—N⁺(CH₃)[CH₂CH₂CH₂—N⁺(CH₃)₃]₂.

The counterions X⁻ are preferably sulfonate ions, such as tosylate ions, and alkyl sulfate ions.

Examples of counterions X⁻ to the positive charge on the quaternary nitrogen atom in the Q radical are CH₃SO₄⁻, CH₃CH₂SO₄⁻, C₆H₅SO₃⁻, p-CH₃(C₆H₄)SO₃⁻, CH₃SO₃⁻, C₄H₉SO₃⁻, and C₈H₁₇SO₃⁻.

The organopolysiloxanes which have quaternary ammonium groups and are obtained by the process according to the invention preferably have a viscosity of 50 to 500,000 mPa·s at 25° C., preferably 200 to 100,000 mPa·s and more preferably 500 to 50,000 mPa·s at 25° C.

The resulting organopolysiloxanes having quaternary ammonium groups contain amine group concentrations in the range of preferably 0.01 to 5.0 meq/g, preferably 0.04 to 2.0 meq/g (meq/g=milliequivalent per g of substance=equivalent per kg of substance).

In principle, the molar SiOR¹/SiOH or SiOR⁵/SiOH ratio in the inventive organopolysiloxanes having quaternary ammonium groups may vary within wide limits; preference is given, however, to the ranges from 0.1 to 0.7 and from 1.2 to 3.0, particular preference to the ranges from 0.3 to 0.7 and from 1.5 to 3.0. In the first case, hydroxyl-functional siloxane polymers are obtained, in the latter case alkoxy-functional siloxane polymers.

In the process according to the invention, the strongly polar alkylating agent (5) surprisingly does not require any addition of water to be able to react. One advantage of the process according to the invention is therefore the high space-time yield. Especially compared to the processes in emulsion, as described in DE 196 52 524 A1 mentioned at the outset, it is possible to achieve 10- to 20-fold space-time yields, based on the quat-functional organopolysiloxanes which constitute the actual active ingredients. This great economic advantage arises from the more compact method as a result of dispensing with aqueous dilution, which is possible by virtue of the unexpectedly good alkylation even without water and the consequent ability to employ higher temperatures, which accelerates the reaction. The product of the two individual advantages synergystically gives rise to the overall advantage.

### EXAMPLE 1

192 g of an organopolysiloxane of the formula HO(Me₂SiO)₁₅₃H which has been baked at 100° C. under reduced pressure are mixed homogeneously with 8 g of diethylaminopropyltrimethoxysilane and 100 mg of a 10% methanolic solution of lithium methoxide. The clear reaction mixture is heated to 80° C. under gentle vacuum to remove the methanol formed for one hour, and 10.5 g of diethylene glycol monobutyl ether and, after 30 minutes, 6.4 g of methyl p-toluenesulfonate are added. The quaternization has ended after 2 hours and the initial turbidity has dissolved again. A clear approx. 95% solution of a quat-functional siloxane with a viscosity of 5100 mPa·s (25° C.) and a concentration of positively charged nitrogen of 0.15 meq/g is obtained. The molar proportion of dimethylsiloxy units in the form of volatile octamethylcyclotetrasiloxane is, according to ²⁹Si NMR, less than 0.1%. No free silane is detectable any longer.

### EXAMPLE 2

196 g of an organopolysiloxane of the formula HO(Me₂SiO)₂₃₈H which has been baked at 100° C. under reduced pressure are mixed homogeneously with 4 g of diethylaminopropyltrimethoxysilane and 50 mg of a 10% methanolic solution of lithium methoxide and kept at 80° C. under gentle vacuum for 2 hours. The clear condensate is admixed with 3.2 g of methyl p-toluenesulfonate and the mixture is left at 100° C. for a further hour to react to completion. A colorless clear polysiloxane is obtained with a concentration of 0.07 meq of quaternary nitrogen per g and a viscosity of 97,000 mPa·s (25° C.). No free silane is detectable in the ²⁹Si NMR, and it contains less than 0.1 mol % of octamethylcyclotetrasiloxane. The product consists 100% of an inventive polysiloxane.

### EXAMPLE 3

196 g of the polydimethylsiloxane used in example 2 are condensed with the same amount of the same aminosilane as in that example to give the tertiary aminosiloxane. 10.5 g of diethylene glycol monobutyl ether are added to the clear product, and the mixture is stirred at the same temperature under reduced pressure for a further 30 minutes. Then 1.7 g of ethyl p-toluenesulfonate are metered in and the mixture is heated to 100° C. for a further hour. A colorless clear solution of a partly quaternized siloxane with a content of positively charged nitrogen of 0.04 meq/g and a viscosity of 10,100 mPa·s (25° C.) is obtained. No free silane is detectable any longer. The molar proportion of dimethylsiloxy units in the form of volatile octamethylcyclotetrasiloxane is approx. 0.1%.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing organopolysiloxanes having quaternary ammonium groups, comprising:
in a first step,
condensing organopolysiloxane(s) (1) which have at least one terminal unit of the formula
HO—SiR²₂O_{1/2} (I)
with aminosilane(s) (2) of the formula
AₐR_{b}Si(OR¹)_{4-(a+b)} (II),
where
A each individually is a monovalent SiC-bonded organic radical which contains at least one tertiary amino group, with the proviso that the A radical contains no primary or secondary amino groups,
R each individually is the same or different and is a monovalent hydrocarbon radical having 1 to 18 carbon atoms,
R¹ is an alkyl radical having 1 to 8 carbon atoms,
a is 1 or 2, and
b is 0 or 1,
with the proviso that the sum of a+b is 1 or 2,
optionally in the presence of catalysts (3), to obtain organopolysiloxanes (4) having tertiary amino groups, and,
in a second step,
partly or fully quaternizing the nitrogen atoms of the organopolysiloxanes (4) obtained in the first step with alkylating agents (5),
with the proviso that no bases are added in the second step and
that, in the process, water is present in amounts of less than 10% by weight, based on the total weight of the components (1), (2), and (3) and (5).

2. The process of claim 1, wherein the organopolysiloxanes (1) used are those of the formula
HOR₂SiO(SiR₂O)ₙSiR₂OH (IV),
where n is 0 or an integer from 1 to 2000.

3. The process of claim 1, wherein the aminosilanes (2) are those of the formula
ARSi(OR¹)₂ and/or ASi(OR¹)₃.

4. The process of claim 2, wherein the aminosilanes (2) are those of the formula
ARSi(OR¹)₂ and/or ASi(OR¹)₃.

5. The process of claim 1, wherein A is a radical of the formula
—R³(—NR⁴—R³)ₙ—NR²₂ (V),
where
R² each are the same or different and are monovalent hydrocarbon radicals which have 1 to 18 carbon atoms and optionally contain one or more tertiary amino groups,
R³ each are divalent SiC-bonded organic radicals having 1 to 18 carbon atoms,
R⁴ each are monovalent hydrocarbon radicals having 1 to 18 carbon atoms and
z is 0 or an integer from 1 to 10.

6. The process of claim 1, wherein A is a radical of the formula
—R³(—NR⁴—R³)_{z}—NR²₂ (V),
where
R² each are the same or different and are monovalent hydrocarbon radicals which have 1 to 18 carbon atoms and optionally contain one or more tertiary amino groups,
R³ each are divalent SiC-bonded organic radicals having 1 to 18 carbon atoms,
R⁴ each are monovalent hydrocarbon radicals having 1 to 18 carbon atoms and
z is 0, 1, or 2.

7. The process of claim 5, wherein R³ is a C₁₋₁₈ hydrocarbon radical.

8. The process of claim 1, wherein basic catalysts (3) are used in the first step of the process.

9. The process of claim 1, wherein alcohols (6) for transesterification of the alkoxy groups —OR¹ are added during or after the condensation in the first step of the process, and alcohol liberated during transesterification is removed.

10. The process as claimed in any one of claim 1, wherein the alkylating agents (5) used in the second step of the process are dialkyl sulfates, sulfonic esters, or mixtures thereof.

11. An organopolysiloxane having quaternary ammonium groups, comprising one of the following:
(i) organopolysiloxanes containing units of the formula
Q(R^{1′}O)₂SiO_{1/2} (VIII), and
R₂SiO (IX),
(ii) organopolysiloxanes containing units of the formula
R₂SiO (IX),
Q(R^{1′}O)SiO (X), and
(R^{1′}O)R₂SiO_{1/2} (XI),
(iii) organopolysiloxanes containing units of the formula
R₂SiO (IX),
(R^{1′}O)R₂SiO_{1/2} (XI) and
QSiO_{3/2} (XII)
and mixtures thereof, where
Q is a monovalent SiC-bonded organic radical which contains at least one quaternary ammonium group, and where a counterion X⁻ to the positive charge on the quaternary nitrogen atom is present in each case, with the proviso that the counterion is not a halide,
R^{1′} is R¹, R⁵ or a hydrogen atom, where
R each individually is the same or different and is a monovalent hydrocarbon radical having 1 to 18 carbon atoms,
R¹ is an alkyl radical having 1 to 8 carbon atoms,
R⁵ is an SiC-bonded hydrocarbon radical which has 4 to 30 carbon atoms and may contain one or more ether oxygen atoms.
